(19) United States
(12) Patent Application Publication
(10) Pub. No.: US 2019/0158943 A1
(43) Pub. Date: May 23, 2019

(54) Sports-Team Related Display

(71) Applicant: Robert Nied, OLDSMAR, FL (US)

(72) Inventor: Robert Nied, OLDSMAR, FL (US)

(21) Appl. No.: 16/198,705

(22) Filed: Nov. 21, 2018

Related U.S. Application Data
(60) Provisional application No. 62/589,226, filed on Nov. 21, 2017.

(51) Int. Cl. H04R 1/02; G09F 23/00; G09F 27/00; G09F 19/00; H04R 3/00

(52) U.S. Cl. CPC H04R 1/025; G09F 23/0066; H04R 3/00; G09F 19/00; G09F 27/00

(57) ABSTRACT

A sports-team related display is an apparatus that is used to decorate a room or area. The apparatus is configured to allow for a user to play the music or chant associated with the related team. The present invention includes a sport-ball-shaped ornament, an audio box, and an ornament holder. The sport-ball-shaped ornament is a model of an athletic ball, such as a football, baseball, soccer ball, or any of a variety of other sports balls. The audio box is a series of electrical and structural components that provide the present invention with the ability to store and play prerecorded team songs and chants. The ornament holder is a mounting device that can support the present invention above a table or other flat surface. This allows positioning of the sport-ball-shaped ornament, and simultaneously prevents the sport-ball-shaped ornament from rolling or moving unexpectedly.

The current application claims a priority to the U.S. Provisional Patent application Ser. No. 62/589,226 filed on Nov. 21, 2017.

### FIELD OF THE INVENTION

The present invention generally relates to sports memorabilia. More specifically, the present invention relates to a sports team display with speakers that emit prerecorded team songs and chants.

### BACKGROUND OF THE INVENTION

The viewing of athletic activities is a staple of modern society. Over the past few decades, various sports have grown from popular past-time activities into several multi-million-dollar industries. It is common to find people who have become die-hard fans of different sports teams represent their teams with multiple varied accessories. Many accessories associated with different sports teams are available, including flags, clothes, wearables, etc. Some popular fan devices are replica balls with a design associated with a sports team. Such balls are often shaped or decorated to represent a specific team's color, symbol, mascot, etc. Many of these balls are designed to be played with, while others are just designed to be used as ornamental devices. The ornamental balls are great accessories for decorating a room, office, etc. Ornamental balls displaying a sports team's colors, symbol, and/or mascot are favorites among sports fans.

Unfortunately, few or none incorporate an important part of sports: a sports team song/chant. Sports team songs/chants are important for fans to support and cheer for their teams. It is common to find fans in a bar to start chanting or singing a team's song/chant while watching their team play. While there are some sports balls that have an integrated speaker system for playing music or sounds while playing with the balls, few ornamental balls have been actually designed to play a team's song/chant. Among those, none have a convenient mount and easy actuation for activating the song/chant. Any sports team fan would love to have an ornamental ball that allows them to play their team's song/chant anytime they want. Thus, an ornamental ball which plays a song/chant of a sports team is beneficial and necessary.

An objective of the present invention is to provide a ball that is designed to represent a sports team's colors, mascot, symbol, etc. Another objective of the present invention is to provide a ball with a sound-emitting mechanism that can play a recorded sports team's song/chant. Another objective of the present invention is to provide a ball which is designed as an ornamental ball with an integrated speaker system. Another objective of the present invention is to provide a ball with talking mechanism which is easy to use and easy to set up. The present invention accomplishes these objectives, providing a decoration that can play songs, chants, and other relevant sports-themed sounds from a sports-themed ball.

### BRIEF DESCRIPTION OF THE DRAWINGS

FIG. 1 is a front perspective view of the present invention.

FIG. 2 is a front-right exploded perspective view of the present invention.

FIG. 3 is a side view of the present invention.

FIG. 4 is a cross-sectional front view of the present invention.

FIG. 5 is a front-left perspective view of the present invention.

FIG. 6 is a cross-sectional schematic view of the audio box.

FIG. 7 is a block diagram representing the electrical connections within the audio box.

### DETAILED DESCRIPTION OF THE INVENTION

All illustrations of the drawings are for the purpose of describing selected versions of the present invention and are not intended to limit the scope of the present invention.

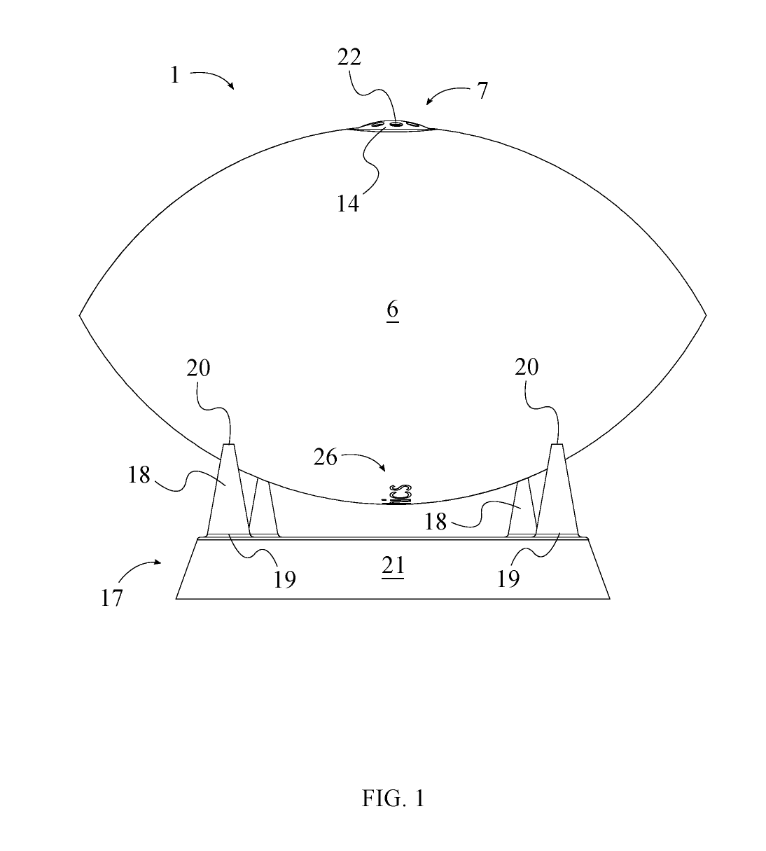

The present invention is a sports-team related display that is used to decorate a room or area. The present invention is configured to allow for a user to play the music or chant associated with the related team. The present invention comprises a sport-ball-shaped ornament 1, an audio box 7, and an ornament holder 17, as seen in FIG. 1. The sport-ball-shaped ornament 1 is a model of an athletic ball, such as a football, baseball, soccer ball, or any of a variety of other sports balls. The audio box 7 is a series of electrical and structural components that provide the present invention with the ability to store and play prerecorded team songs and chants. The ornament holder 17 is a mounting device that can support the present invention on a table or other flat surface. In this way, the present invention allows for arrangement of the sport-ball-shaped ornament 1 in a desirable position.

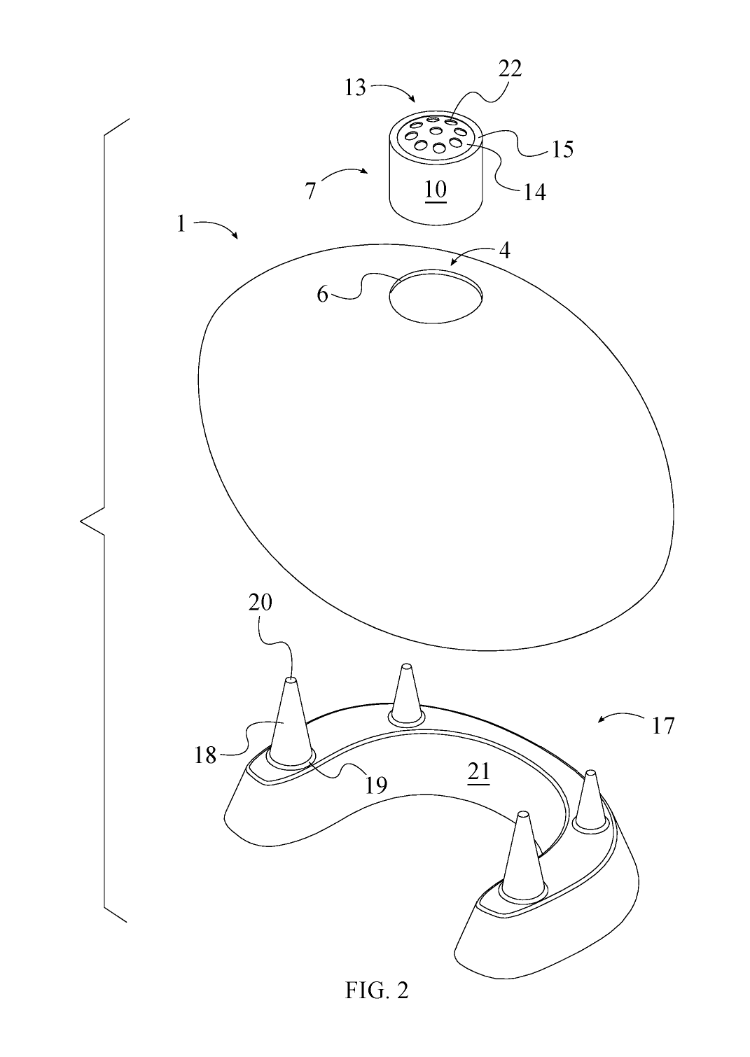

The general configuration of the aforementioned components allows the present invention to efficiently and effectively play athletic team music, chants, and other sounds. The sport-ball-shaped ornament 1 comprises an ornament body 2 and a box-receiving cavity 3, as seen in FIG. 2. The ornament body 2 is the physical shape of the sport-ball-shaped ornament 1 that is used in arranging the box-receiving cavity 3. The box-receiving cavity 3 is a space adapted for placement of the audio box 7 into the ornament body 2. The audio box 7 comprises a resting end 8 and an actuation end 9. The resting end 8 is the end which fits into the box-receiving cavity 3 first, thus properly orienting the audio box 7. The actuation end 9 is the end of the present invention used to play music and other prerecorded sounds. The box-receiving cavity 3 comprises a cavity opening 4 and a cavity base 5. The cavity opening 4 is the entrance to the box-receiving cavity 3. The cavity base 5 is the bottom of the box-receiving cavity 3. The box-receiving cavity 3 traverses into the ornament body 2. This arrangement helps to arrange the audio box 7. Further, the audio box 7 is mounted into the box-receiving cavity 3. In this way, the audio box 7 is positioned appropriately and sufficiently protected from physical damage. The resting end 8 is positioned adjacent to the cavity base 5. In addition, the actuation end 9 is positioned adjacent to the cavity opening 4. This arrangement ensures that the user can access the actuation end 9 during use of the present invention. The sport-ball-shaped ornament 1 is mounted onto the ornament holder 17. This arrangement ensures that the sport-ball-shaped ornament 1 is situated upon a table or other flat surface as desired by the user.

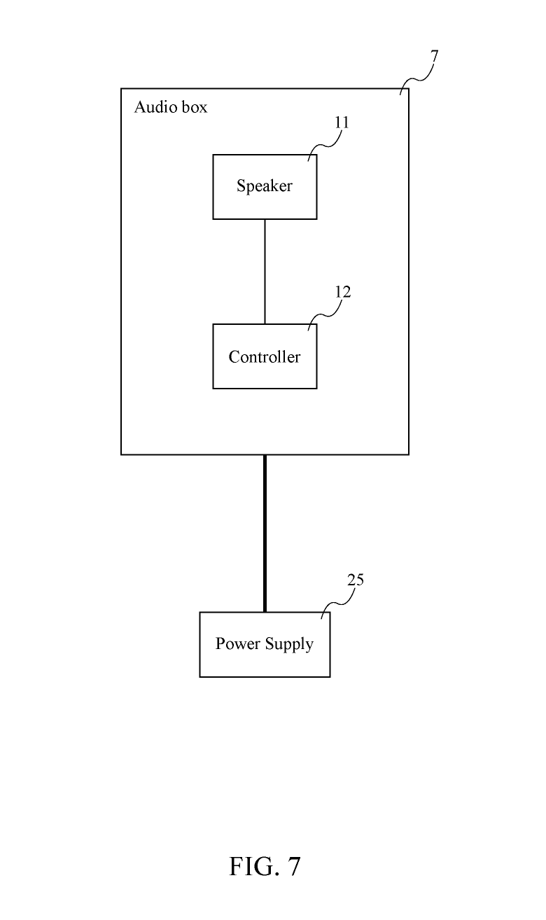

The audio box 7 requires components that will allow the audio box 7 to produce music and sounds. To this end, the audio box 7 comprises a housing 10, a speaker 11, a controller 12, and a button 13. The housing 10 encloses the other components of the audio box 7. The speaker 11 is an electrical component that allows for the transformation of electrical signals into sound waves, thus allowing for the projection of music and other sounds into a room. The controller 12 is an electrical device which accepts electric inputs and returns corresponding electrical signal outputs. The button 13 is an input that allows for user interaction with the controller 12. The button 13 is bistably mounted to the actuation end 9. In this way, the button 13 is able to switch between an on position and an off position. The speaker 11 and the controller 12 are mounted within the housing 10. This arrangement allows for mechanical proximity of the speaker 11 and the controller 12. The speaker 11 is positioned between the button 13 and the controller 12. Furthermore, the speaker 11 is oriented toward the cavity opening 4. In this way, sound produced by the speaker 11 is not interfered with by the controller 12. The button 13 and the speaker 11 are electronically connected to the controller 12, as seen in FIG. 7. This arrangement ensures that electrical signals can be effectively transmitted to and from the controller 12. Upon pressing the button 13, the controller 12 responds by sending musical patterns in the form of electrical signals to the speaker 11, which responds by converting those signals into the programmed music or sounds.

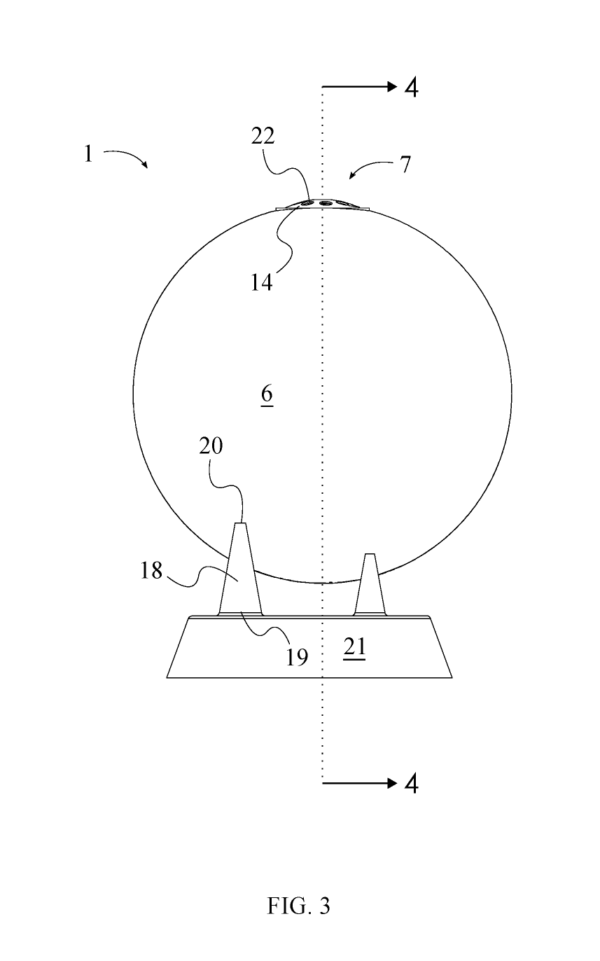

The present invention requires a mechanism for emitting sound effectively. To this end, the present invention comprises a plurality of sound-emitting holes 22. The plurality of sound-emitting holes 22 is a series of cuts that improve the ability of the speaker 11 to project outside of the audio box 7, as seen in FIG. 3. The plurality of sound-emitting holes 22 traverses through the button 13. Furthermore, the plurality of sound-emitting holes 22 is distributed across the button 13. This arrangement allows sound waves from the speaker 11 to evenly project outside the audio box 7 into the surrounding area.

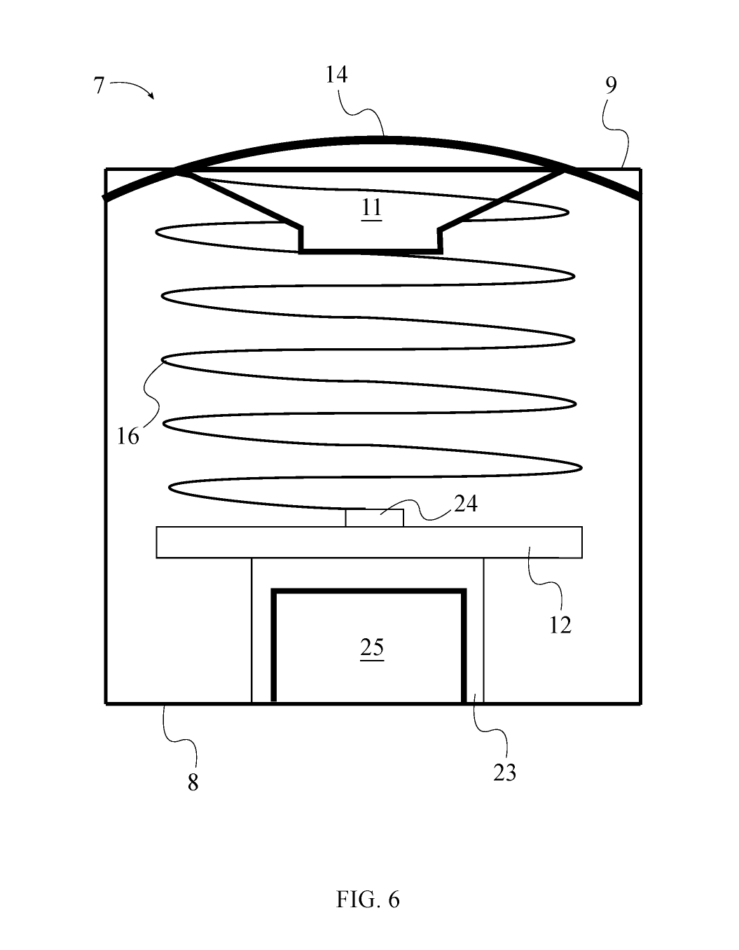

The button 13 has to be prepared to actuate smoothly to allow for user interaction with the present invention. To this end, the button 13 comprises a press panel 14, a stopping lip 15, and a compression spring 16, as seen in FIG. 6. The press panel 14 is a rigid unit that allows the user to interact with the button 13. The stopping lip 15 is a rigid segment that prevents the button 13 from being pushed too far out of position by the compression spring 16. The compression spring 16 is a unit which stores and releases mechanical energy, which biases the button 13 towards the stopping lip 15. The compression spring 16 is mounted in between the press panel 14 and the controller 12. In this way, the compression spring 16 allows the press panel 14 to bias away from the controller 12. The speaker 11 is encircled by the compression spring 16. This allows the speaker 11 to avoid any damage due to actuation of the press panel 14. The actuation end 9 is perimetrically connected to the stopping lip 15. In this way, the button 13 is oriented towards the actuation end 9. An outer diameter of the press panel 14 is greater than an inner diameter of the stopping lip 15. This arrangement prevents the press panel 14 from being pushed beyond the stopping lip 15.

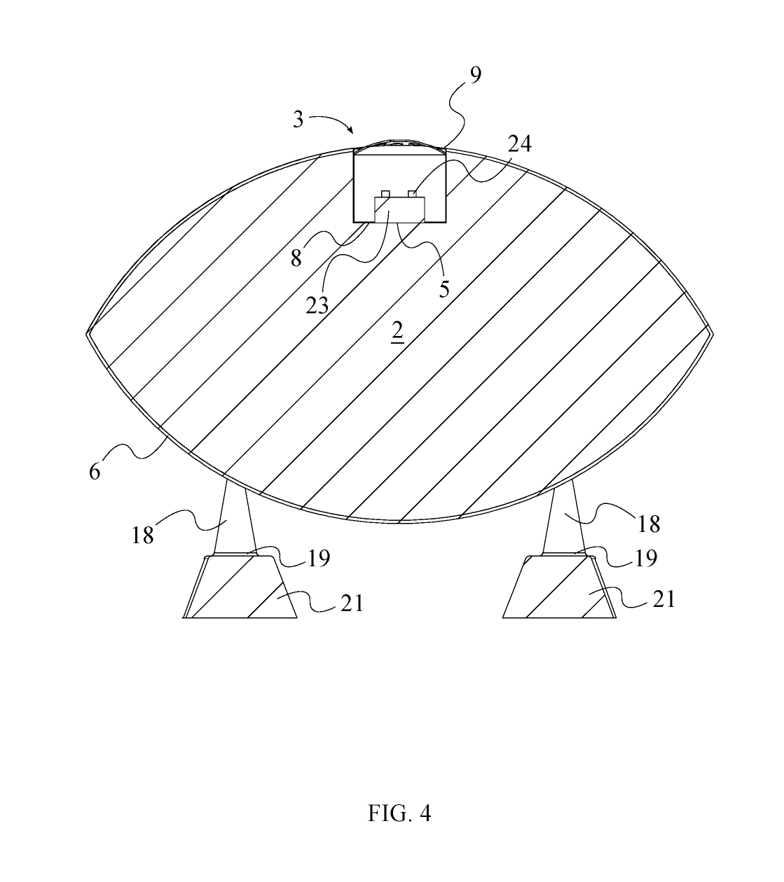

In order to actuate properly, the compression spring 16 needs to compress appropriately within the audio box 7. To this end, the present invention comprises a structural support 23 and at least one button-pressing nub 24. The structural support 23 is a rigid unit extending within the audio box 7. The at least one button-pressing nub 24 is rigid segment that actuates the button 13 as the button 13 is pushed into the housing 10, as seen in FIGS. 4 and 6. The structural support 23 is positioned within the housing 10. This enables the structural support 23 to hold the controller 12 in place. The structural support 23 is mounted onto the resting end 8. This enables appropriate positioning of the controller 12. The controller 12 is mounted onto the structural support 23, opposite the resting end 8. In this way, the controller 12 is securely connected to the housing 10. The at least one button-pressing nub 24 traverses through the controller 12. This arrangement allows the at least one button-pressing nub 24 to contact the compression spring 16. The at least one button-pressing nub 24 is mounted onto the structural support 23, opposite the resting end 8. This arrangement allows the controller 12 to be lofted away from the resting end 8.

The audio box 7 requires a mechanism for providing power to the controller 12. To this end, the present invention comprises a power supply 25. The power supply 25 is a battery, set of batteries, electrical cord, or other such portable or non-portable power sources capable of providing the controller 12 and electrical components with adequate power, as seen in FIG. 7. The power supply 25 is electrically connected to the audio box 7. In this way, the power supply 25 is capable of providing the audio box 7 with electrical power.

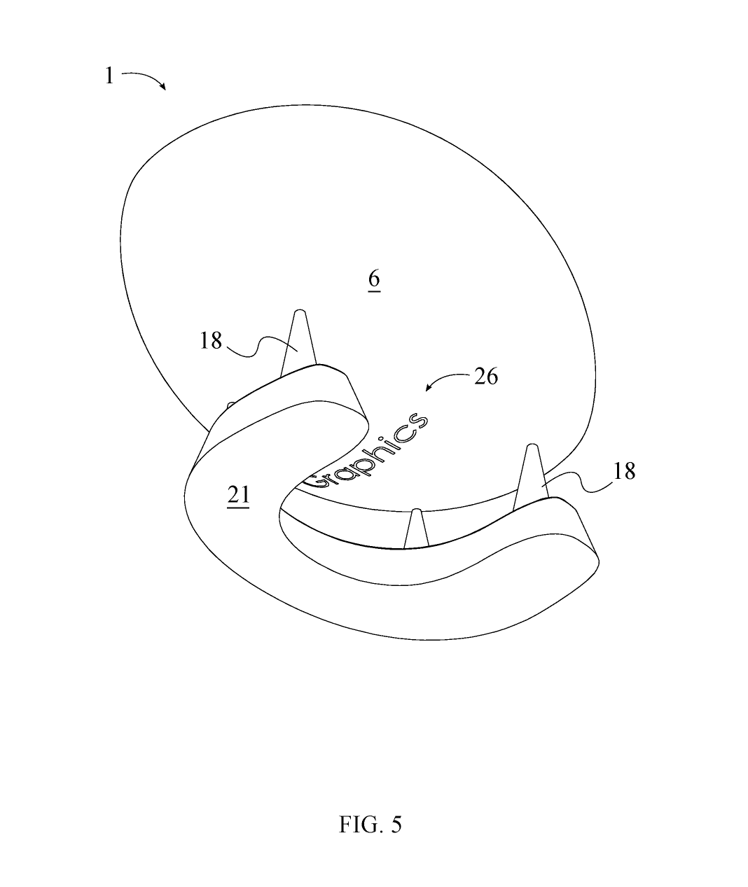

The ornament holder 17 functions best when equipped to support the sport-ball-shaped ornament 1. To this end, the ornament holder 17 comprises a plurality of protrusions 18 and a base panel 21, as seen in FIG. 5. The plurality of protrusions 18 is a set of rigid extrusions that enable optimal contact with the sport-ball-shaped ornament 1. The base panel 21 is a segment that contacts a flat surface, such as a table or shelf, positioning the plurality of protrusions 18 so that the sport-ball-shaped ornament 1 is suspended away from the surface. Each of the plurality of protrusions 18 comprises a first end 19 and a second end 20. The first end 19 and the second end 20 are used for positioning and arrangement of the plurality of protrusions 18. The first end 19 for each of the plurality of protrusions 18 is connected onto the base panel 21. Conversely, the second end 20 for each of the plurality of protrusions 18 is oriented away from the base panel 21. This arrangement results in the plurality of protrusions 18 extending away from the base panel 21.

The present invention is fully-adapted for both comfort in a user's hand and display of graphics and designs. To this end, in an exemplary embodiment, the ornament body 2 is made of a polyester resin foam. This gives the ball comfortable hand feel when squeezed. In another exemplary embodiment, the sport-ball-shaped ornament 1 further comprises a vulcanized shell 6. The vulcanized shell 6 is any of a variety of flexible rubber exteriors that improves the user's grip upon the present invention. The ornament body 2 is enclosed by the vulcanized shell 6, as seen in FIG. 4. This allows for uniform ball feel around the sport-ball-shaped ornament 1. In an exemplary further embodiment, the present invention comprises at least one printed graphic 26. The at least one printed graphic 26 is a logo or other visual indicator of team affiliation. The at least one printed graphic 26 is inscribed into the vulcanized shell 6. This ensures that the at least one printed graphic 26 is permanently visible to viewers.

Although the invention has been explained in relation to its preferred embodiment, it is to be understood that many other possible modifications and variations can be made without departing from the spirit and scope of the invention as hereinafter claimed.

What is claimed is:

1. A sports-team-related display comprises:
a sport-ball-shaped ornament;
an audio box;
an ornament holder;
the sport-ball-shaped ornament comprises an ornament body and a box-receiving cavity;
the audio box comprises a resting end and an actuation end;
the box-receiving cavity comprises a cavity opening and a cavity base;
the box-receiving cavity traversing into the ornament body;
the audio box being mounted into the box-receiving cavity;
the resting end being positioned adjacent the cavity base;
the actuation end being positioned adjacent to the cavity opening; and
the sport-ball-shaped ornament being mounted onto the ornament holder.

2. The sports-team-related display as claimed in claim 1 comprises:
the audio box comprises a housing, a speaker, a controller, and a button;
the button being bistably mounted to the actuation end;
the speaker and the controller being mounted within the housing;
the speaker being positioned in between the button and the controller;
the speaker being oriented towards the cavity opening; and
the button and the speaker being electronically connected to the controller.

3. The sports-team-related display as claimed in claim 2 comprises:
a plurality of sound-emitting holes;
the plurality of sound-emitting holes traversing through the button; and
the plurality of sound-emitting holes being distributed across the button.

4. The sports-team-related display as claimed in claim 2 comprises:
the button comprises a press panel, a stopping lip, and a compression spring;
the compression spring being mounted in between the press panel and the controller;
the speaker being encircled by the compression spring;
the actuation end being perimetrically connected to the stopping lip; and
an outer diameter of the press panel being greater than an inner diameter of the stopping lip.

5. The sports-team-related display as claimed in claim 2 comprises:
a structural support;
at least one button-pressing nub;
the structural support being positioned within the housing;
the structural support being mounted onto the resting end;
the controller being mounted onto the structural support, opposite the resting end;
the at least one button-pressing nub traversing through the controller; and
the at least one button-pressing nub being mounted onto the structural support, opposite the resting end.

6. The sports-team-related display as claimed in claim 1 comprises:
a power supply; and
the power supply being electrically connected to the audio box.

7. The sports-team-related display as claimed in claim 1 comprises:
the ornament holder comprises a plurality of protrusions and a base panel;
each of the plurality of protrusions comprises a first end and a second end;
the first end for each of the plurality of protrusions being connected onto the base panel; and
the second end for each of the plurality of protrusions being oriented away from the base panel.

8. The sports-team-related display as claimed in claim 1, wherein the ornament body is made of a polyester resin foam.

9. The sports-team-related display as claimed in claim 1 comprises:
the sport-ball-shaped ornament further comprises a vulcanized shell; and
the ornament body being enclosed by the vulcanized shell.

10. The sports-team-related display as claimed in claim 9 comprises:
at least one printed graphic; and
the at least one printed graphic being inscribed into the vulcanized shell.

11. A sports-team-related display comprises:
a sport-ball-shaped ornament;
an audio box;
an ornament holder;
the sport-ball-shaped ornament comprises an ornament body and a box-receiving cavity;
the audio box comprises a resting end, an actuation end, a housing, a speaker, a controller, and a button;
the box-receiving cavity comprises a cavity opening and a cavity base;
the box-receiving cavity traversing into the ornament body;
the audio box being mounted into the box-receiving cavity;
the resting end being positioned adjacent the cavity base;
the actuation end being positioned adjacent to the cavity opening;
the sport-ball-shaped ornament being mounted onto the ornament holder;
the button being bistably mounted to the actuation end;
the speaker and the controller being mounted within the housing;
the speaker being positioned in between the button and the controller;
the speaker being oriented towards the cavity opening; and
the button and the speaker being electronically connected to the controller.

12. The sports-team-related display as claimed in claim 11 comprises:
a plurality of sound-emitting holes;
the plurality of sound-emitting holes traversing through the button; and
the plurality of sound-emitting holes being distributed across the button.

13. The sports-team-related display as claimed in claim 11 comprises:
the button comprises a press panel, a stopping lip, and a compression spring;
the compression spring being mounted in between the press panel and the controller;
the speaker being encircled by the compression spring;
the actuation end being perimetrically connected to the stopping lip; and
an outer diameter of the press panel being greater than an inner diameter of the stopping lip.

14. The sports-team-related display as claimed in claim 11 comprises:
a structural support;
at least one button-pressing nub;
the structural support being positioned within the housing;
the structural support being mounted onto the resting end;
the controller being mounted onto the structural support, opposite the resting end;
the at least one button-pressing nub traversing through the controller; and
the at least one button-pressing nub being mounted onto the structural support, opposite the resting end.

15. The sports-team-related display as claimed in claim 11 comprises:
a power supply; and
the power supply being electrically connected to the audio box.

16. The sports-team-related display as claimed in claim 11 comprises:
the ornament holder comprises a plurality of protrusions and a base panel;
each of the plurality of protrusions comprises a first end and a second end;
the first end for each of the plurality of protrusions being connected onto the base panel; and
the second end for each of the plurality of protrusions being oriented away from the base panel.

17. The sports-team-related display as claimed in claim 11, wherein the ornament body is made of a polyester resin foam.

18. The sports-team-related display as claimed in claim 11 comprises:
the sport-ball-shaped ornament further comprises a vulcanized shell; and
the ornament body being enclosed by the vulcanized shell.

19. The sports-team-related display as claimed in claim 18 comprises:
at least one printed graphic; and
the at least one printed graphic being inscribed into the vulcanized shell.
